(19) United States
(12) Patent Application Publication
(10) Pub. No.: US 2011/0282862 A1
(43) Pub. Date: Nov. 17, 2011

(54) SYSTEM AND METHOD FOR PREVENTING NFORMATION INFERENCING FROM DOCUMENT COLLECTIONS

(75) Inventors: Shoshana K. Loeb, Philadelphia, PA (US); Euthimios Panagos, Madison, NJ (US)

(73) Assignee: TELCORDIA TECHNOLOGIES, INC., Piscataway, NJ (US)

(21) Appl. No.: 12/779,993

(22) Filed: May 14, 2010

(51) Int. Cl. G06F 17/30

(52) U.S. Cl. 707/710; 707/E17.108

(57) ABSTRACT

A method for preventing information inferencing from documents comprises creating a document collection view from the documents, obtaining rules based on information to be hidden, establishing a plurality of levels of the rules, said levels ranging from a shallow level to a deepest level, for each level of the rules, from the shallow level to the deepest level, examining the document collection view in accordance with the level of the rules, when said examining detects inferencing, performing trace and repair on the document collection view, and outputting the document collection view. Examining can be performed using a search engine, a natural language processing engine, and a conceptual inferencability engine. The shallow level can correspond to a search engine, a deep level can correspond to a natural language processing engine, and a deepest level can correspond to a conceptual inferencability engine. The documents can be data in digital form.

### FIELD OF THE INVENTION

The present invention relates generally to privacy protection, information elimination, information filtering, semantic analysis, inference engines, natural language processing and artificial intelligence.

### BACKGROUND OF THE INVENTION

Collections of documents may contain information the document owners may want to hide from some readers. Such information may be either mentioned explicitly in one or more documents in the collection or inferred from specific information present in a document. For example, a business owner may collect detailed information about his business methods and processes. Some portions of this information may be available to the public but other portions may be trade secrets. The business owner desires to protect not only the detailed description of the trade secrets but also information from which an outsider could derive the trade secrets. Similarly, a patient may which to protect his or her medical records, not only masking information regarding specialists seen and/or medicines taken but also hiding references to medication that may cause side effects when taken in conjunction with the one prescribed.

The problem of hiding information has been approached by two main disciplines: the security/cryptography community, which hides portions of information by encrypting them, and the information processing community, which hides portions of information by deleting or masking them in some way. Both communities assume that sensitive information is identified by either a human or a software component using exact value matching or pattern matching in the original document collection; the inferencing problem is not addressed. In other words, searches for specific key words and/or patterns of words are used to detect information to be protected.

Typically, to conceal this sensitive information, one can either eliminate or hide the portion of the text that contains the sensitive information to be protected in specific application domains, document formats, and information schemas. Elimination of sensitive information (referred to as redaction) in Microsoft® Office Word, Adobe® PDF files, and other textual documents is a well known practice that requires human involvement for either removing or altering parts of a document. For well-structured documents and information sources, e.g., databases, data masking techniques have been used for the purpose of masking sensitive values by replacing these values with either null or realistic but not real values. Finally, a number of commercial and open-source software packages are available for developing workflows that can delete or hide sensitive information in a variety of document formats using matching rules based on regular expressions.

Prior solutions are mostly designed to solve the problem for highly structured documents in which content types are isolated and the content is simple. But even in the case of structured documents, prior solutions fail to address information that may be inferred from the actual contents. The same is true for solutions that solve the problem in unstructured documents and are based on regular expressions or some other pattern matching techniques. For example, if a patient is diagnosed with diabetes, existing solutions may remove references to the specific diagnosis from his record but may fail to remove information that could be used for inferring the diagnosis, such as treatments of side effects and implicit information about the impact of diabetes on the patient's life.

### SUMMARY OF THE INVENTION

An inventive solution to the need to prevent private information inferencing from document collections is presented. The novel solution provides a way to prevent undesired sensitive information inferencing by eliminating or modifying the places in the original document where such inferencing could be enabled. The approach handles both structured and unstructured documents and is based on Artificial Intelligence (AI) methodology related to deep conceptual representation of documents. The inventive technique entails the use of deep domain and world knowledge about the domain addressable by the documents. The inventive method employs various techniques including “inferencability”, that is, the ability to determine whether inferences about a specific condition, state, situation, etc. can be made.

The inventive method has steps of creating a document collection view from the documents, obtaining rules based on information to be hidden, establishing a plurality of levels of the rules, the levels ranging from a shallow level to a deepest level, for each level of the rules, from the shallow level to the deepest level: examining the document collection view in accordance with the level of the rules, when said examining detects inferencing, performing trace and repair on the document collection view; and outputting the document collection view after all levels of the rules are processed. In one embodiment, examining can be performed using a search engine, a natural language processing engine, and a conceptual inferencability engine. In one embodiment, the shallow level of the rules corresponds to a search engine, a deep level of the rules corresponds to a natural language processing engine, and the deepest level of the rules corresponds to a conceptual inferencability engine. The documents can be data in digital form.

The inventive system comprises one or more engines, each engine operable on a processor, a document collection view created from the documents, an output device for displaying the document collection view, rules based on information to be hidden, and a plurality of levels of the rules, the levels ranging from a shallow level to a deepest level, each level corresponding to one of said one or more engines, wherein, for each engine, the engine examines the document collection view and when the engine detects inferencing, trace and repair is performed on the document collection view. In one embodiment, the engines can be at least a search engine, a natural language processing engine, and a conceptual inferencability engine. In one embodiment, the shallow level of the rules corresponds to a search engine, a deep level of the rules corresponds to a natural language processing engine, and the deepest level of the rules corresponds to a conceptual inferencability engine. The documents can be data in digital form.

A program storage device readable by a machine, tangibly embodying a program of instructions executable by the machine to perform methods described herein may be also provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a high level flow diagram of the detection and repair process;

FIG. 2 is a high level flow diagram of possible document processing stages to detect inferencability;

FIG. 3 is a high level flow diagram of document processing to detect conceptual inferencability;

FIG. 4 shows an example of nested knowledge structures that capture domain expertise for deep document inference analysis; and

FIG. 5 is a high level flow diagram of an exemplary embodiment.

### DETAILED DESCRIPTION

The invention comprises a method and a system to prevent private information inferencing from document collections. The solution enables a user, or data owner, to control which facts in the data are available to whom. The inventive approach involves applying rich domain information in the form of AI knowledge structures to “understand” the information present in a document or set of documents and determine whether specific sensitive information can be inferred. For example, it will apply “theorem proving” or “backward chaining” techniques to determine whether specific assumptions (e.g., the patient has diabetes) can be proven by “connecting the dots” at various levels of interpretation in a given set of documents.

Imagine a situation where all the medical documents of John Smith are stored and available in a health vault. These documents may include medical information about office visits, medical tests, prescriptions, and/or insurance records, as well as, perhaps, email exchanges between various physicians, and other electronic communications. Also imagine that John Smith is a veteran of the first Gulf War and at some point in the past he suffered post traumatic stress and associated drug addiction. Further, imagine that he has fully recovered and is now the CEO of a NASDAQ traded company. One of the reasons John did not want to put all of his medical records, past and present, in a health vault was because he wanted to keep his medical past unavailable to some of his doctors.

The same scenario emerges when a cancer survivor who is cancer free for ten years does not want all of his physicians to know about his deep past medical history, or when someone may not want his General Practitioner, who is also a neighbor, to know that he is seeing a psychiatrist.

The problem in providing the privacy protection that these patients are looking for is that the information they are looking to hide may not be easily separable from the rest of the records. As a result, implications of the private information are sprinkled across many documents either directly or in an easily inferable form by anyone familiar with the domain. For example, if the patient is seeing an oncologist for comprehensive testing every year, it may be inferred that he is a cancer survivor, or if he currently is suffering from specific joints problem, it may be inferred that he has been exposed to intensive chemotherapy in the past.

The medical scenarios above are just one example of the need for better ways to separate private information from a collection of records where the boundaries between private and public are not easily identifiable from the structure of the documents. Other examples can include business scenarios in which business expansion plans need to be kept confidential, and/or research scenarios in which problem-solving approaches need to remain secret. For example, a business' patent filings reveal information about the business' research and development which could be used adversely by its competitors but could also be helpful in the business' quest to obtain capital. Thus, the business may wish to make such filings known only to specific venture capitalists. Note that the invention is not limited to these exemplary situations.

An inventive system and a method for the identification of private information that can be inferred from a set of documents and the elimination of this information from the documents when possible is presented. The goal of the system and method is to make sure that certain inferences are NOT made during document reading. To achieve this goal, rules are created to determine what is to be hidden and then these rules are implemented so that the determined data is masked and/or removed from the information output and/or displayed by the system. The inventive process includes “how to build the rules”. The rules enumerate specific names and/or synonyms for which the data will be searched; these rules further define inferences and inference terms, which can be domain specific and/or application specific.

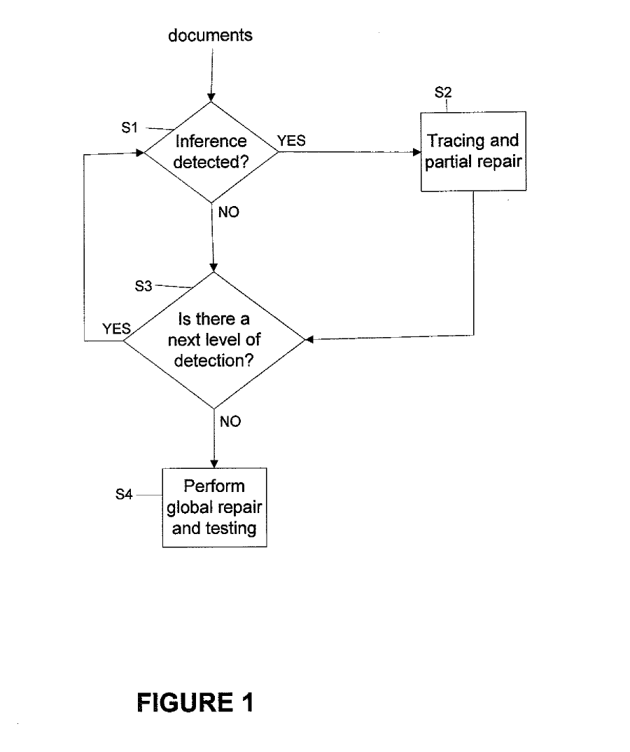

FIG. 1 depicts the high level flow of the invention. In this diagram, the system takes as input a set of documents (structured and unstructured) as well as a description of the information, e.g., a list of facts, that the user perceives as private and would like to hide from specific users or specific classes of users. The system may operate in a continuous mode, analyzing the collection of documents every time they are modified, or the system can operate on demand. It also can be running the evaluation for a specific person that is trying to access the user's information when needed, e.g., on demand, or can run or evaluate in advance for several types of users.

The system has deep domain knowledge about the subject matter of the documents and, also, it can apply several analysis tools and methods for understanding the collection of documents at different depths. Here is a simple example: if a document describes “visit to Cardiologist on Nov. 20, 2009”, this can be interpreted literally as a visit on that date. It can also be interpreted as the third visit that month to this particular Cardiologist (given knowledge about the patient) and then the system may infer various possible reasons and outcomes, etc.

The system operates as follows. It starts at the most shallow level of understanding, typically pattern matching or phrase recognition. If mention of specific private information is detected, e.g., a specific word or phrase is found, it is flagged and some repair suggestions are indicated, such as deleting the sentence, replacing the word or phrase with a more general phrase that does not directly imply the phrase in question, etc. For example, the phrase “visit to cardiologist” may be replaced with “visit to a doctor” or “visit to a professional” or “office visit”, etc. Whether or not information is detected and/or flagged and/or repaired, upon completion of the review at the most shallow level, the system then continues and applies the next level of depth of understanding. Here again if mention of the private information can be inferred from the document, the parts of the document that triggered the inferences are flagged and some repair suggestions are indicated. Either way, upon completion of review at this level, the system then continues and applies greater and greater amounts of domain expertise. When the application of inferencing mechanisms is complete, the system tries to repair the documents if possible and then runs the process again on the repaired documents to test whether the cleanup and repair were effective.

As shown in FIG. 1, documents provide input to the system. In step S1, it is determined whether or not inference is detected in the documents. If so (S1=YES), in step S2, tracing and repair are performed to address the detected inference. If not (S1=NO), or after S2 is performed, it is determined whether there is a next level of detection. If so (S3=YES), the process resumes at step S1. Otherwise (S3=NO), global repair and testing is performed at step S4.

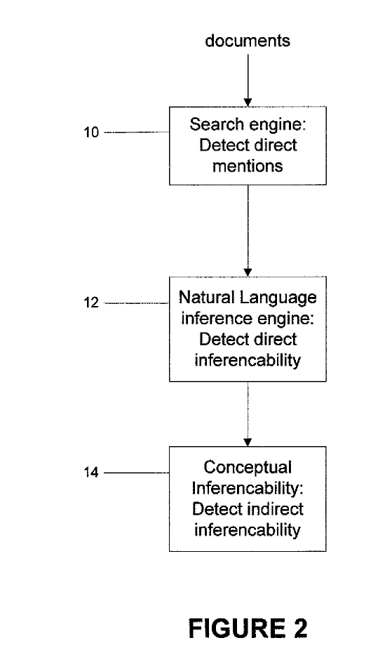

FIG. 2 depicts a few examples of inferencing mechanisms that can be applied in step S1. The first is a search engine 10 looking for literal or close to literal mention of the private information in the document; this would typically be used in a most shallow level of understanding. The second is a semantic natural language understanding inference engine 12 equipped with sufficient domain knowledge to interpret the documents. The third is a conceptual understanding engine 14 with causal knowledge and a broader view on the subtleties of the domain. Such engines have been developed as part of research in AI over the last several years and their mechanisms can be adopted for use in this invention with the appropriate domain expertise. These engines are exemplary and the invention is not limited to these inferencing mechanisms.

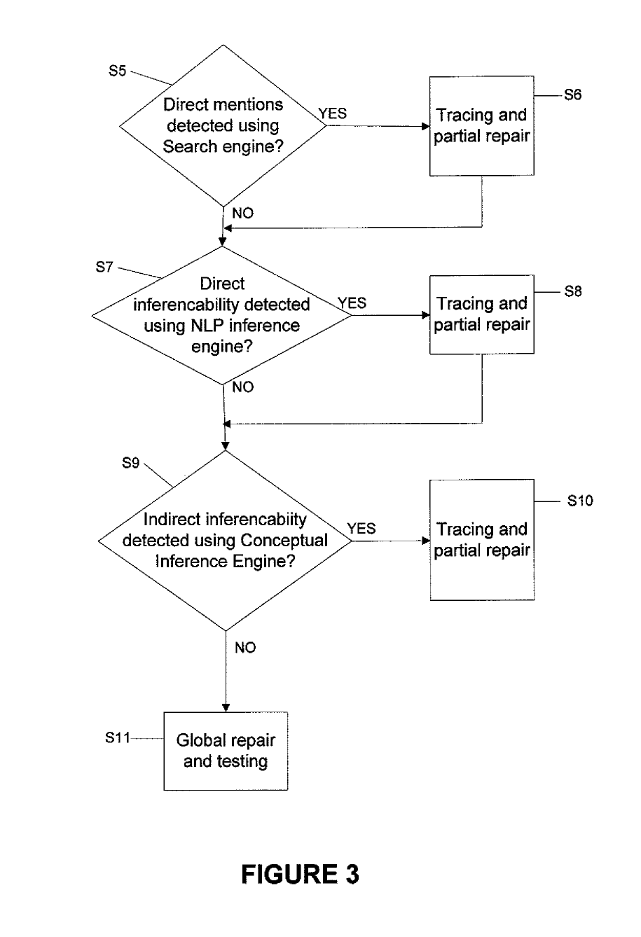

FIG. 3 is the merge of FIGS. 1 and 2 and illustrates an example flow. In step S5, search engine 10 is used to determine whether direct mentions of a particular item are found in the documents. If so (S5=YES), in step S6, tracing and repair are performed to address the detected inference. If not (S5=NO), or after S6 is performed, it is determined whether direct inferencability is detected using an NLP inference engine 12. If so (S7=YES), tracing and repair are performed in step S8. If no directed inferencability is detected, or after the tracing and repair are performed in step S8, it is determined whether indirect inferencability is detected in step S9. If so (S9=YES), tracing and repair are performed in step S10. Otherwise (S9=NO), or after step S10 is performed, global repair and testing is performed at step S11.

Below is a detailed example of the system and method.

A health record vault has a newly established collection of medical records and correspondence between a patient (“John”) and his various physicians as well as correspondence between John's physicals for a period of six years. John provided the above information to the vault under the condition that he will control who will have access to what information about him. In particular, since some of his physicians do not know of each other, John wanted to keep certain information separate. For instance, he did not want his General Practitioner (his family doctor) to know that John and John's wife are going to marriage therapy which is paid for by their health plan. Since the treatment did not involve medications, John did not see any reason why this doctor needed to know this especially since he had a “big mouth” and was often gossiping to John about other patients they both knew in the neighborhood. At the same time, John wanted his Marriage Therapist and his Cardiologist to have access to all of his medical information. He trusted both of them and thought that if they had a global view of his health and circumstances they may be able to develop a more efficient treatment path. As time went on, John's Marriage Therapist had conversations with John's Cardiologist about the possibility that some of John's heart medications may increase his vulnerability to stress and, hence, affect his marriage. The Marriage Therapist recommended taking daily walks as well as an occasional yoga class to reduce stress.

The system and method described here will be used to create a view of John's medical record that hides the fact that he and his wife are seeing a Marriage Therapist. This view of the records is going to be the only view available to the General Practitioner when he views the medical database. Here are the steps that the system will be taking to accomplish this information hiding.

As shown in step S5 in FIG. 3, the system will search for records' names and in records' text for an explicit mention of the Marriage Therapist's name and any other specific information about him (address, etc). This information may also include specific emails and phone call records of communication between the therapist and other physicians such as the Cardiologist. These records will be eliminated from the view of the medical documents that the General Practitioner is entitled to access.

As shown in step S7 in FIG. 3, the system will then examine the remaining, e.g., not eliminated, collection of documents for information that can lead a knowledgeable person to infer that John is seeing a Marriage Therapist. At this step, a Natural Language Processing (NLP) engine 12 will parse the text of the documents and will attempt to piece together a picture of John's healthcare/well being life. Using the relevant domain knowledge about marriage therapy, its causes, implications, side effects and the like, the system will try to see if it can conclude that John is seeing a Marriage Therapist. AI has produced a variety of inferencing mechanisms and “knowledge representation” methodologies that can be used in this case. For example, if there is an indication of the Cardiologist being concerned with John having sudden changes in stress levels (either increase or decrease) which may involve medications and recommendation to exercise, the inference may be made that something has changed in his professional or personal life and the inferred cause for it may be, among other things, problems in his marriage. When this is detected, the system may remove any mention of changes in stress level; this removal may involve deleting text, hiding and/or masking text, and/or removing entire records or documents from the collection available for the General Practitioner's view.

In step S9 in FIG. 3, the remaining collection of documents is analyzed by an inference engine with broader world knowledge to look for other indications (perhaps not medical) that can lead a person to conclude that something may be off for John in the area of his marriage. This may include noticing that although John's address has not changed legally, he now resides in a small one bedroom apartment and the pharmacy has this new address but no one else. This fact is unusual and the system will infer that something may be off in his personal life. This new address will be hidden from the General Practitioner accessing the records.

The example above illustrates the type of information that can be detected and inferred by the inventive system described here.

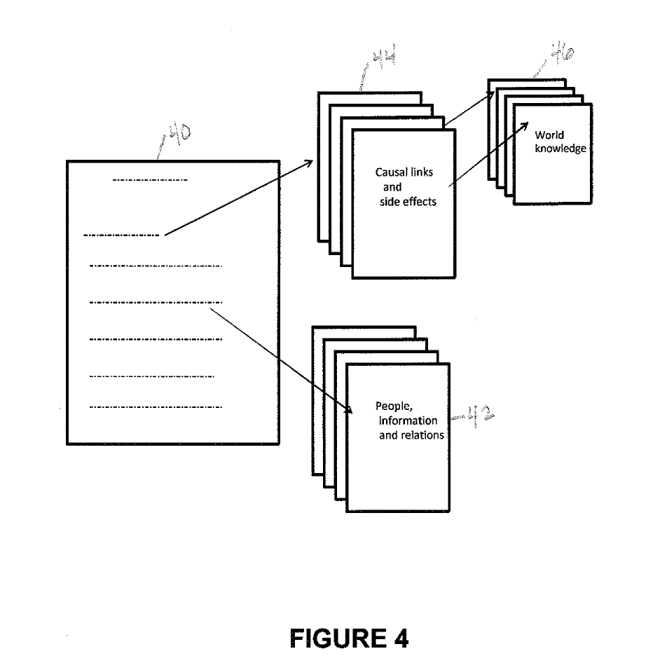

FIG. 4 shows examples of how domain knowledge structures 40 can be organized in linked “frames” and/or “schemas”. FIG. 4 shows a collection of people, information and relations 42 obtained directly from the domain knowledge structure 40. Another collection shown in FIG. 4 is a collection of causal links and side effects 44 which is also obtained directly from the domain knowledge structure 40. Yet another collection is one of world knowledge 46, derived from the causal links and side effects 44. These are exemplary data collections and the invention is not limited to them.

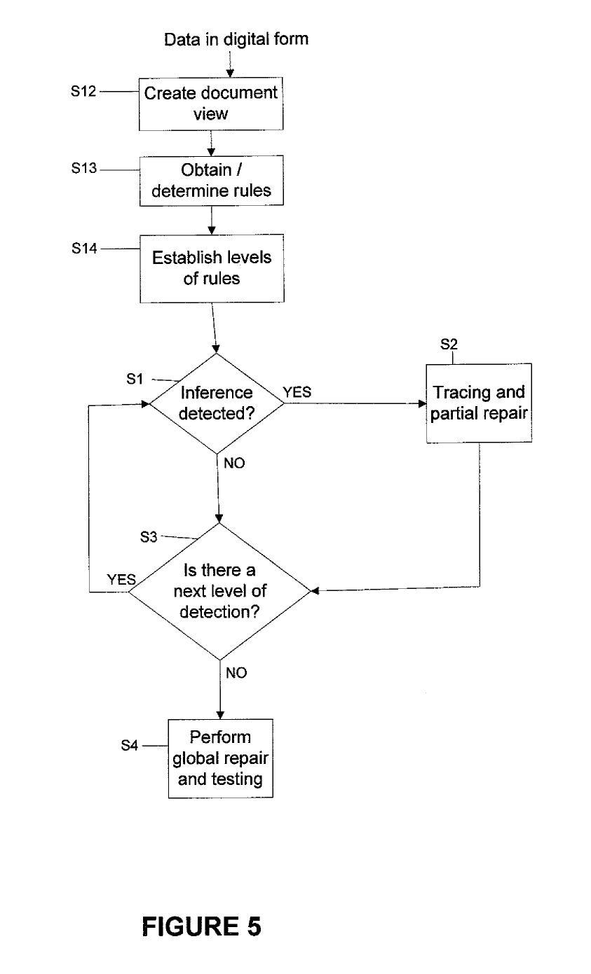

FIG. 5 is a high level flow diagram of an exemplary embodiment of the inventive system. In step S12, a document collection view is created from the input data in digital form. In step S13, rules, that is, a description of the data to be hidden, is obtained and/or determined. In step S14, levels of the rules are created. The levels can range from a shallow level to a deepest level. In one embodiment, the shallow level corresponds to word and/or pattern matching which can be implemented using a search engine 10 or other direct detection means. In this embodiment, a deep level corresponds to natural language matching which can be implemented using natural language inference engine 12 or other direct detection of inferencability means. Also in this embodiment, a deepest level corresponds to conceptual inferencability 14 which can be implemented using indirect detection of inferencability means. Steps S1 through S4 in FIG. 5 are performed as described in FIG. 1.

FIGS. 1 and 2 show “documents” as input to the system but any data in digital form can provide input. Data in numerous formats can be processed, including a set of documents, data in one or more databases, data in non-database repositories, scanned images converted to text, images with metadata, images with attributes such as size, location, etc. These collections of data and/or documents generally do not remain static.

The inventive system and method can be implemented in a variety of ways. It can be embedded as part of the storage of data or it can stand apart from the data and be accessed by one or more data repositories. In a distributed network, the system can reside in a central location or on one or more of the nodes in the network. A system that examines only one type of document, such as a word processing file, a spreadsheet, etc., can also be implemented.

The system parses the document in accordance with rules to see whether particular inferences can be made. The data owner specifies who can see what.

The system outputs a view of the data or document collection. In one embodiment, the view of the data includes information that is redacted. The output can be on a computer monitor, computer display screen, hand-held device, mobile computing device, printer, or other device.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for preventing information inferencing from documents, comprising:
one or more engines, each engine operable on a processor;
a document collection view created from the documents;
an output device for displaying the document collection view;
rules based on information to be hidden; and
a plurality of levels of the rules, said levels ranging from a shallow level to a deepest level, each level corresponding to one of said one or more engines, wherein, for each engine, the engine examines the document collection view and when the engine detects inferencing, trace and repair is performed on the document collection view.

2. The system according to claim 1, wherein the engines are at least a search engine, a natural language processing engine, and a conceptual inferencability engine.

3. The system according to claim 1, wherein the shallow level of the rules corresponds to a search engine, a deep level of the rules corresponds to a natural language processing engine, and a deepest level of the rules corresponds to a conceptual inferencability engine.

4. The system according to claim 1, wherein the documents are data in digital form.

5. A method for preventing information inferencing from documents, comprising
creating a document collection view from the documents;
obtaining rules based on information to be hidden;
establishing a plurality of levels of the rules, said levels ranging from a shallow level to a deepest level;
for each level of the rules, from the shallow level to the deepest level:
examining the document collection view in accordance with the level of the rules;
when said examining detects inferencing, performing trace and repair on the document collection view; and
outputting the document collection view.

6. The method according to claim 5, wherein the step of examining is performed using at least a search engine, a natural language processing engine, and a conceptual inferencability engine.

7. The method according to claim 5, wherein the shallow level of the rules corresponds to a search engine, a deep level of the rules corresponds to a natural language processing engine, and a deepest level of the rules corresponds to a conceptual inferencability engine.

8. The method according to claim 5, wherein the documents are data in digital form.

9. A computer readable storage medium storing a program of instructions executable by a machine to perform a method for preventing information inferencing from documents, comprising
creating a document collection view from the documents;
obtaining rules based on information to be hidden;
establishing a plurality of levels of the rules, said levels ranging from a shallow level to a deepest level;
for each level of the rules, from the shallow level to the deepest level:
examining the document collection view in accordance with the level of the rules;
when said examining detects inferencing, performing trace and repair on the document collection view; and
outputting the document collection view.

10. The medium according to claim 5, wherein the step of examining is performed using at least a search engine, a natural language processing engine, and a conceptual inferencability engine.

11. The medium according to claim 5, wherein the shallow level of the rules corresponds to a search engine, a deep level of the rules corresponds to a natural language processing engine, and a deepest level of the rules corresponds to a conceptual inferencability engine.

12. The medium according to claim 9, wherein the documents are data in digital form.
